(19) United States
(12) Patent Application Publication
(10) Pub. No.: US 2026/0311686 A1
(43) Pub. Date: Oct. 8, 2026

(54) EVALUATION OF VOICE-BASED ARTIFICIAL INTELLIGENCE (AI) AGENTS

(71) Applicant: Salesforce, Inc., San Francisco, CA (US)

(72) Inventors: Manjeet SINGH, San Francisco, CA (US); Deepak MUKUNTHU, Sammamish, WA (US); Maxwell COMPARETTO, New York, NY (US); John EMMONS, Blaine, MN (US)

(21) Appl. No.: 19/466,257

(22) Filed: Jan. 30, 2026

Related U.S. Application Data
(60) Provisional application No. 63/783,712, filed on Apr. 4, 2025.

(51) Int. Cl. G10L 15/01; G06N 20/00; G10L 15/06

(52) U.S. Cl. CPC G10L 15/01; G06N 20/00; G10L 15/063

(57) ABSTRACT

An apparatus may map, to voice-based interaction scenarios, personas that indicate respective voice-based interaction characteristics based on a subset of stored training data that are representative of the respective voice-based interaction characteristics. The apparatus may train an AI testing model capable of performing voice-based interactions in accordance with a first voice-based interaction scenario and that are based on the respective voice-based interaction characteristics indicated by a first persona. The apparatus may provoke, in accordance with a testing protocol, a first voice-based interaction between the artificial intelligence (AI) testing model and the AI agent. The apparatus may evaluate the first voice-based interaction based on one or more voice interaction metrics. The apparatus may generate a report indicating the one or more voice interaction metrics and one or more results of the evaluation.

### CROSS REFERENCE

The present Application for Patent is a continuation of U.S. Provisional Patent Application No. 63/783,712 by SINGH et al., entitled “EVALUATION OF VOICE-BASED ARTIFICIAL INTELLIGENCE (AI) AGENTS,” filed 4 Apr. 2025, which is assigned to the assignee hereof and is expressly incorporated by reference herein.

### FIELD OF TECHNOLOGY

The present disclosure relates generally to database systems and data processing, and more specifically to evaluation of voice-based artificial intelligence (ai) agents.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some scenarios, a cloud platform may engage artificial intelligence (AI) agents to interact with clients via voice interactions. However, such approaches may be improved.

### BRIEF DESCRIPTION OF THE DRAWINGS

FIG. 1 illustrates an example of a system that supports evaluation of voice-based artificial intelligence (AI) agents in accordance with examples as disclosed herein.

FIG. 2 shows an example of an evaluation scheme that supports evaluation of voice-based AI agents in accordance with examples as disclosed herein.

FIG. 3 shows an example of an evaluation scheme that supports evaluation of voice-based AI agents in accordance with examples as disclosed herein.

FIG. 4 shows an example of a process flow that supports evaluation of voice-based AI agents in accordance with examples as disclosed herein.

FIG. 5 shows a block diagram of an apparatus that supports evaluation of voice-based AI agents in accordance with examples as disclosed herein.

FIG. 6 shows a block diagram of an evaluation manager that supports evaluation of voice-based AI agents in accordance with examples as disclosed herein.

FIG. 7 shows a diagram of a system including a device that supports evaluation of voice-based AI agents in accordance with examples as disclosed herein.

FIG. 8 shows a flowchart illustrating methods that support evaluation of voice-based AI agents in accordance with examples as disclosed herein.

### DETAILED DESCRIPTION

Existing training methodologies for artificial intelligence (AI) agent training are primarily focused on text (e.g., accuracy, tone, completeness, or other metrics), but lack the nuance involved in training robust voice-based agents. For example, operation of voice-based agents may involve many involve other factors not present in text-based agents, including tone of voice, emotions, background noise, interruptions, speech patterns, and other factors. As such, existing approaches for text-based agents cannot be applied to voice-based agents.

The techniques described herein employ a comprehensive evaluation framework for incorporating both text-based and voice-based testing, using novel metrics for evaluating the voice-specific aspects of agent performance. For example, a system may provoke realistic voice interactions (e.g., between an AI agent that is “under test” and a generated AI testing agent), including a diverse range of personas, persona characteristics, background noise, and other elements present in voice-based conversations, that are used to train voice-based agents across a wide range of real-world examples without having to manually interact with the agents. The voice-based metrics that are evaluated include at least conciseness, responsiveness, interruption handling, and empathy. This solution allows for comprehensive evaluation of the nuanced aspects of voice interactions, and facilitates standardized and scalable testing framework.

Aspects of the disclosure are initially described in the context of an environment supporting an on-demand database service. Aspects of the disclosure are then described with reference to a wireless communications system, evaluation schemes, and a process flow. Aspects of the disclosure are further illustrated by and described with reference to apparatus diagrams, system diagrams, and flowcharts that relate to evaluation of voice-based artificial intelligence (ai) agents.

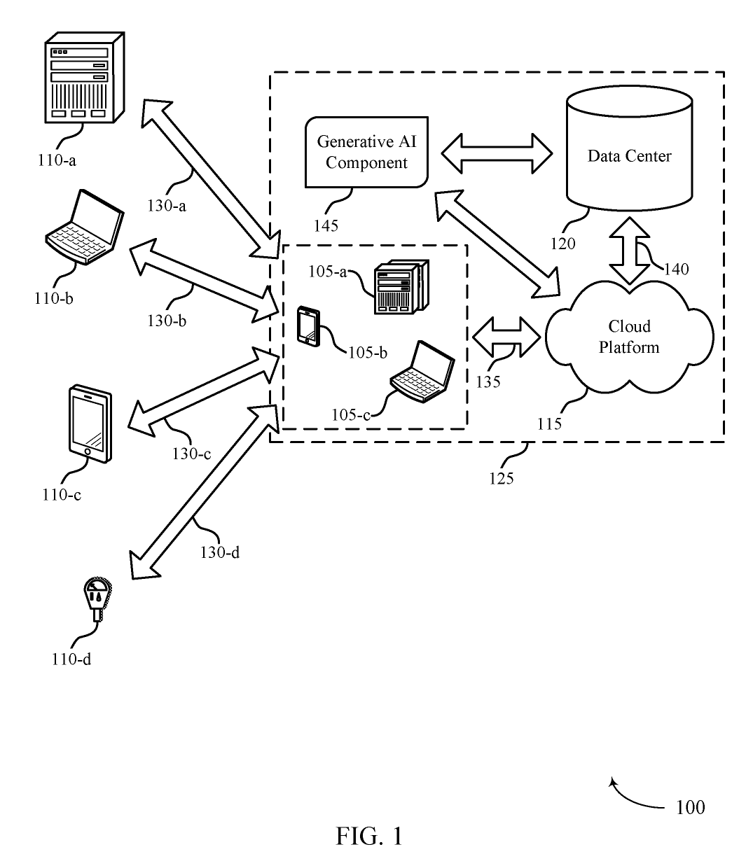

FIG. 1 illustrates an example of a system 100 for cloud computing that supports evaluation of voice-based AI agents in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative AI component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology’s output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

For example, to evaluate an AI agent (e.g., that may be supported by or utilize the generative AI component 145) for voice-based interactions, a cloud platform 115 may map voice-based interaction scenarios to personas (e.g., both of which may be stored in the data center 120) that indicate or include voice-based interaction characteristics. Such characteristics may be based on a subset of stored training data (e.g., stored in the data center 120) that are representative of the respective voice-based interaction characteristics. The cloud platform 115 may train an AI testing model (e.g., that is based on or utilizes the generative AI component 145) that is capable of performing voice-based interactions in accordance with a first voice-based interaction scenario and that are based on the respective voice-based interaction characteristics indicated by a first persona. The cloud platform 115 may provoke, in accordance with a testing protocol, a first voice-based interaction between the AI testing model and the AI agent. The cloud platform 115 may evaluate the first voice-based interaction based on one or more voice interaction metrics. The cloud platform 115 may generate a report indicating the one or more voice interaction metrics and one or more results of the evaluation.

Existing approaches to evaluating agents are generally based on text-based interactions and contemplate metrics and techniques for such text-based interactions. However, such metrics and techniques fall short of adequately evaluating voice-based interactions, as voice-based interactions may involve many characteristics and events that are not present in text-based interactions. Such characteristics may include diverse speech patterns and accents, context of voice-specific clues (e.g., tonality and pronunciation), user emotions and their impact on agent performance, interruptions, context interpretation and awareness, one or more other characteristics, or any combination thereof.

The techniques described herein may include a comprehensive evaluation framework incorporating both text-based and voice-based testing. For example, by generating an AI testing agent and provoking voice-based interactions between the AI testing agent and the AI agent (e.g., the agent “under test” or being evaluated), evaluation of the AI agent may be performed using a variety of personas, conversation characteristics, events (e.g., interruptions), contexts, and scenarios. Novel metrics for evaluating voice-specific aspects of agent performance may be employed that are tailored for voice-based interactions, including conciseness, responsiveness, interruption handling, empathy, and other metrics described herein. A system is described for simulating realistic voice interactions, including diverse user personas and injection of real-world conversation disturbances (e.g., background noise). The described system integrates the use of emotion detection and interruption handling mechanisms, among other approaches that are unique to evaluating AI agents in the context of voice interactions.

It should be appreciated by a person skilled in the art that one or more aspects of the disclosure may be implemented in a system 100 to additionally, or alternatively, solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

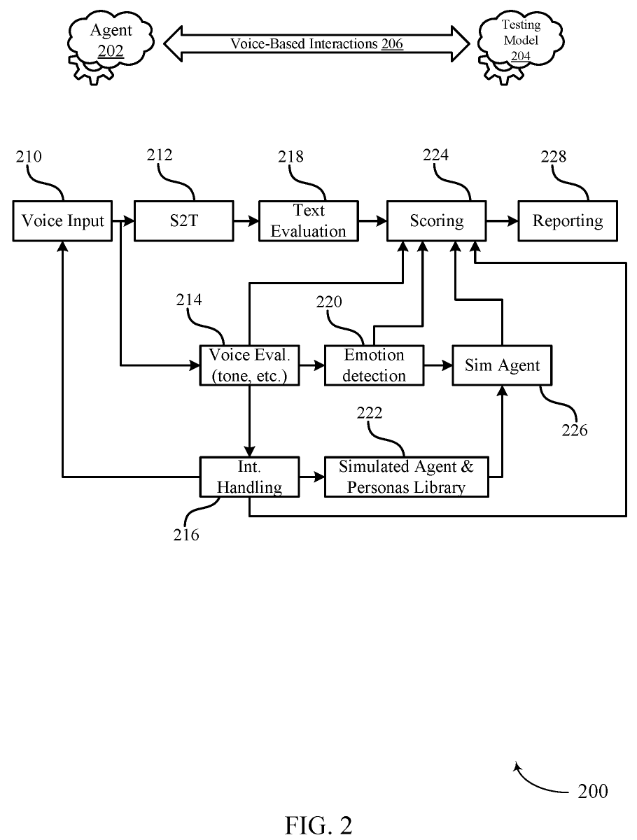

FIG. 2 shows an example of an evaluation scheme 200 that supports evaluation of voice-based AI agents in accordance with examples as disclosed herein. The evaluation scheme 200 may evaluate the voice-based interactions 206 performed between the agent 202 (e.g., the agent that is “under test” for evaluation of its voice-based interactions) and the testing model 204, which may also be referred to as an AI testing model. Though some information flows or connections are shown, any element in the evaluation scheme 200 may be connected with any other element, and information may flow freely between any set of the depicted elements. Further, though some information flows or connections are depicted, such information flows or connections are only non-limiting examples.

Voice-based AI agents are rapidly evolving, and robust evaluation methodologies may be desirable to promote improved performance and user experience. Existing evaluation methods primarily focus on text-based interactions, neglecting the (at times, unique) characteristics of voice communication. For example, some current evaluation methods fail to capture the complexities of voice interactions, leading to inaccurate performance assessments. Thus, it becomes clear that evaluations of voice-based interactions performed by AI agents may be improved.

The subject matter described herein includes comprehensive evaluations of voice-based AI agents, addressing key aspects such accurate transcription of diverse speech patterns and accents, evaluation of agent responses in the context of voice-specific cues (e.g., tonality, pronunciation), measurement of user emotions and their impact on agent performance, interruption handling, context maintenance and awareness in voice conversations.

In some examples, evaluation of AI agents, such as the agent 202, may include an evaluation framework that incorporates both text-based and voice-based testing, metrics for evaluating voice-specific aspects of agent performance, simulation of realistic voice interactions (e.g., including various user personas, characteristics, and interaction scenarios, including background noise), emotion detection, and interruption handling mechanisms.

In some examples, at 210, the scheme may include reception of voice input from the voice-based interactions 206. The voice input may include voice data generated by an AI agent (e.g., the agent that is “under test” for evaluation), the AI testing agent (e.g., an agent that is generating conversation for the AI agent under evaluation to respond to), or both.

In some examples, at 212, the scheme may include speech to text translation that may generate text from the voice-based interactions 206.

In some examples, at 214, the scheme may include an evaluation of the voice data generated by the agent 202. For example, such evaluation may be based on one or more voice-based interaction metrics, including conciseness, responsiveness, and empathy. The conciseness metric may measure how effectively the agent 202 conveys information without unnecessary verbosity. In some examples, the conciseness metric may be compared with a threshold or average length of responses. In some examples, the conciseness metric may encourage a target response length that aligns with user expectations (e.g., as indicated in AI training data or other data) and avoid excessive detail unless explicitly requested. The responsiveness metric may track the speed and naturalness of responses, including pauses and acknowledgment during interactions. For example, the metric may measure a “velocity” of words per minute (or other metric of the velocity) and may compare the measurements to a threshold or average values. In some examples, the responsiveness metric may encourage targets of response times that mimic human standards (e.g., within a threshold range around one or more average or representative human “velocity” values) and with minimal delays (e.g., under 1 second or another threshold for processing). The empathy metric may assess the agent’s ability to respond politely and with understanding to user needs, frustrations, or urgency. For example, the metric may be associated with user-rated empathy scores, with a goal of empathy score of 4.5/5 or higher.

In some examples, at 216, the scheme may include interruption handling operations and metrics. Such operations may include one or more evaluations of the agent’s ability to handle interruptions gracefully, without losing context or failing to respond. For example, the evaluation may determine (e.g., based on one or more metrics) whether the agent 202 looped back to finish interactions that were interrupted or an amount of time to do so, and may compare the evaluation to one or more thresholds. The interruption handling may encourage seamless transitions when interrupted to maintain relevance and context.

In some examples, at 218, the scheme may include evaluation of the transcription of the voice-based interactions. In some examples, sentiment analysis or other text-based techniques may be used to supplement the voice-based interaction measurements.

In some examples, at 220, the scheme may include emotion detection. For example, the agent 202 may engage in emotion detection to determine an emotion being expressed by the testing model 204. The agent 202 may be evaluated to determine whether the agent 202 correctly identified one or more emotions indicated in a testing scenario or one or more characteristics thereof, personas being expressed by the testing model or one or more characteristics thereof, or any combination thereof. For example, an evaluating entity may be provided with the persona and testing scenario being represented by the testing model 204, either or both of which may indicate one or more emotions being expressed by the testing model 204, and a comparison of the emotion detection performed by the agent 202 and the emotions indicated in the persona or testing scenario may be performed.

In some examples, at 222, the scheme may include a simulated agent (e.g., the testing model 204) and one or more personas. The personas may include indications of emotions, actions, interactions, characteristics, or other information that may represent a simulation of a human actor that may be employed by the testing model 204 during a provoked voice-based interaction 206 between the agent 202 and the testing model 204. The personas, interaction scenarios, or both, may be stored in a library or repository that may be accessed by the testing model 204 to access one or more personas, interaction scenarios, or both, to be employed during the voice-based interactions 206. The library of personas may represent a collection of user profiles with different communication styles. Some examples of such personas may be an impatient customer, a busy executive, an angry customer, or a customer in a noisy environment (e.g., at a café). In some examples, the scenarios or personas may include background noise of the noisy environment that may be injected during the provoked voice-based interactions 206. The use of the persona library supports training, configuration, and evaluation across a broad range of personas, scenarios, and scripts, for both general tasks as well as tasks that may be associated with or have access to information associated with a client or entity that may eventually deploy the agent 202.

In some examples, a user may select one or more personas to be used for evaluating the agent 202. In some examples, a user may further select one or more characteristics, emotions, scenarios, identities, voice characteristics (e.g., accent, speaking speed, tone of voice, etc.), or any combination thereof to generate personas, which may be stored in the persona library and made accessible by the testing model 204. In some examples, the personas and interaction scenarios may be indicated or stored in training data that may be used to train the testing model 204 to respond in accordance with the personas and interaction scenarios. In some examples, the interaction scenarios may include one or more scripts (e.g., predefined interaction steps or operations), one or more portions of which may be performed verbatim or may be interpreted by the testing model 204 to generate interaction elements of the voice-based interactions 206. In some examples, a system evaluating the agent 202 may cycle through a series of personas, interaction scenarios, or both, (e.g., from the library) to evaluate the agent 202 in a variety of situations, identify points for improvement, and refine the agent 202 (e.g., through altering one or more aspects of one or more configurations associated with the agent 202).

In some examples, at 224, the scheme may include performance scoring operations that may aggregate outputs, reports, metrics, measurements, or other information for packaging, formatting, and reporting (e.g., at 228). The reports generated at 224 maybe human-readable reports or may include or indicate structured data that may be interpreted by a system to identify points where additional training, fine-tuning, or other refinement may be performed on the agent 202 to improve it, after which additional evaluations may be performed. Such an iterative process may be repeated indefinitely to continually improve the agent 202 with new personas, interaction scenarios, any characteristics or elements of personas or interaction scenarios, or any combination thereof.

In some examples, at 226, the scheme may include a sim agent, which may be an alternative term for the testing model 204. The testing model 204 may generate realistic voice interactions based on the personas, interaction scenarios, scripts, any other information described herein, or any combination thereof, thereby supporting automated testing and scalability of evaluation that would otherwise not be possible. The sim agent may operate based on one or more of the other elements present in the evaluation scheme 200, scoring thereof, reporting thereof, or any combination thereof. For example, one or more parameters of the sim agent may be adjusted based at least in part on one or more scores corresponding to the voice evaluation, the emotion detection, the interruption handling, the speech to text operations, the text evaluation, one or more aspects of the simulated agent and personas library, or any combination thereof. Such changes may be made based on whether a generated score satisfies one or more thresholds corresponding to the scoring performed at 224.

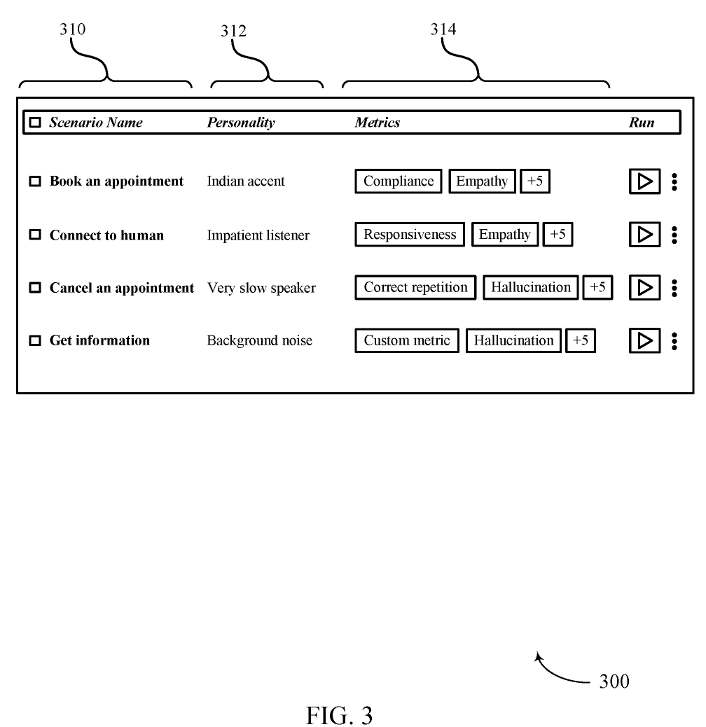

FIG. 3 shows an example of an evaluation scheme 300 that supports evaluation of voice-based AI agents in accordance with examples as disclosed herein. The evaluation scheme 300 depicts an example of a persona 312 and scenario 310 library that further indicates the metrics 314 that are to be used to evaluate the agent “under test.” For example, the first entry indicates a scenario 310 for booking an appointment and the persona indicates that the AI testing model is to perform the voice-based interactions with an Indian accent. The system may perform the evaluation of the AI agent based on compliance and empathy metrics and provide a report of how well the AI agent interacted with the Indian accent persona 312 in the appointment booking scenario 310. Similarly, the second entry indicates a scenario 310 for connecting to a human (e.g., on a phone call to an automated system) and the persona indicates that the AI testing model is to perform the voice-based interactions as an impatient listener. The system may perform the evaluation of the AI agent based on responsiveness and empathy metrics and provide a report of how well the AI agent interacted with the Indian accent persona 312 in the appointment booking scenario 310. Any combination of any scenarios 310, personas 312, and metrics 314 may be employed to perform the evaluations.

In some examples, the metrics 314 to be used may be based on the scenario 310, the persona 312, one or more characteristics thereof, or any combination thereof. For example, a human caller wanting to connect a call to another human may exhibit impatient characteristics, and the agent should be evaluated accordingly. The metrics 314 may be designated or selected based on user input or may be automatically selected (e.g., randomly or based on an agent analysis of previous operations).

The evaluation scheme 300 may further provide for a user interface (e.g., the interface depicted in FIG. 3) for a user to select and run one or more evaluation scenarios to evaluate a given AI agent. The user may select one or more parameters corresponding to the scenario 310, the personality 312, the metrics 314, any other parameters described herein, or any combination thereof, to configure the evaluation of one or more AI agents.

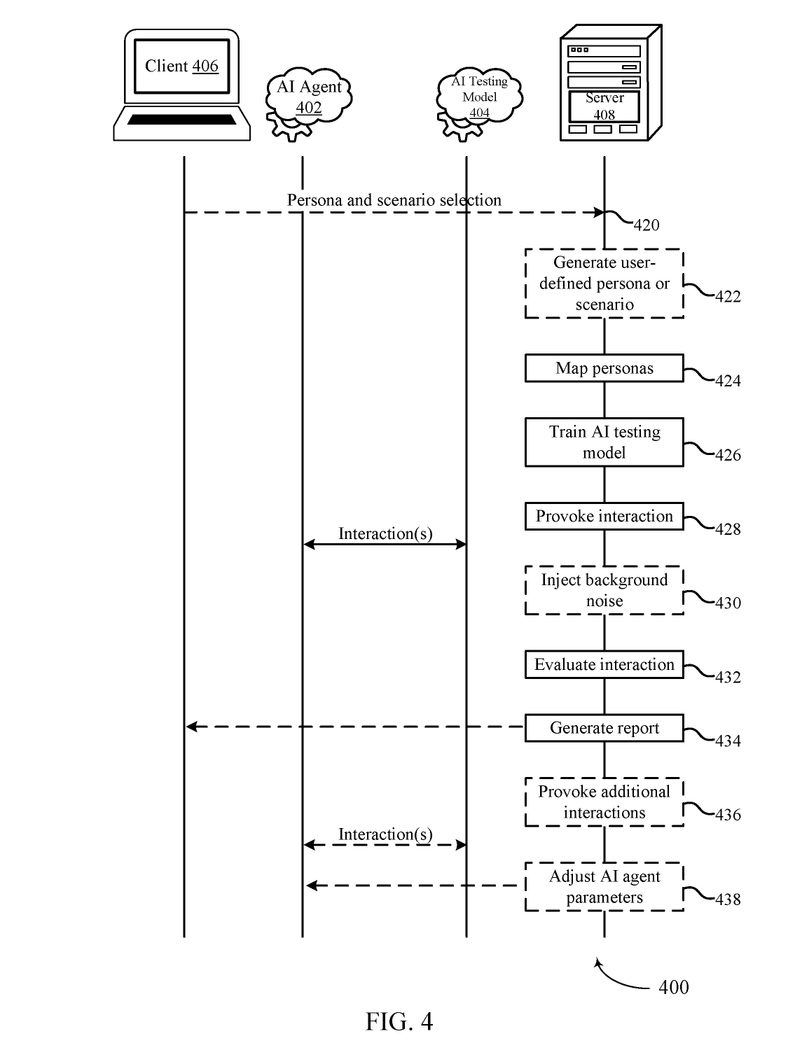

FIG. 4 shows an example of a process flow 400 that supports evaluation of voice-based AI agents in accordance with examples as disclosed herein.

The process flow 400 may implement various aspects of the present disclosure described herein. The elements described in the process flow 400 (e.g., AI agent 402, AI testing model 404, client 406, and server 408) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

In some examples, at 420, the server 408 may receive (e.g., from the client 406) input indicating a first selection of the first persona from among the plurality of personas and a second selection of the first voice-based interaction scenario from among the plurality of voice-based interaction scenarios.

In some examples, at 422, the server 408 may generate, based on received input indicating a selection of one or more voice-based interaction characteristics of the plurality of voice-based interaction characteristics, a user-defined persona. In some examples, the server 408 may associate the user-defined persona with the plurality of personas. In some examples, the server 408 may generate, based on received input indicating one or more interaction scenario characteristics, a user-defined voice-based interaction scenario. In some examples, the server 408 may associate the user-defined voice-based interaction scenario with the plurality of voice-based interaction scenarios.

In some examples, at 424, the server 408 may map, to a plurality of voice-based interaction scenarios, a plurality of personas that each indicate a plurality of respective voice-based interaction characteristics that are based on a subset of stored training data that are representative of the plurality of respective voice-based interaction characteristic. In some examples, each persona of the plurality of personas may indicate one or more conversational elements associated with one or more moods, one or more roles, one or more tones, one or more emotions, one or more interruption events, or any combination thereof, that are indicated by the subset of the stored training data.

In some examples, at 426, the server 408 may train an AI testing model 404 capable of performing voice-based interactions that are in accordance with a first voice-based interaction scenario of the plurality of voice-based interaction scenarios and that are based on the respective voice-based interaction characteristics indicated by a first persona of the plurality of personas.

In some examples, at 428, the server 408 may provoking, in accordance with a testing protocol, a first voice-based interaction between the AI testing model 404 and the AI agent 402. In some examples, the AI agent 402 is configured to perform, in connection with the first voice-based interaction, a sentiment analysis of voice input received at the AI agent 402.

In some examples, at 430, the server 408 may inject background noise corresponding with the first voice-based interaction scenario into the first voice-based interaction and evaluating the first voice-based interaction may include evaluating one or more responses generated by the AI agent 402 in response to the background noise.

In some examples, at 432, the server 408 may evaluate the first voice-based interaction based on one or more voice interaction metrics. In some examples, the one or more voice interaction metrics comprise a conciseness metric, a responsiveness metric, an interruption handling metric, an empathy metric, a sentiment analysis metric, or any combination thereof. In some examples, the evaluation of the first voice-based interaction is based on an evaluation of the sentiment analysis. In some examples, to evaluate the first voice-based interaction, the server 408 may evaluate one or more responses generated by the AI agent 402 to the one or more conversational elements that are generated by the AI testing model 404.

In some examples, at 434, the server 408 may generate a report indicating the one or more voice interaction metrics and one or more results of the evaluation.

In some examples, at 436, the server 408 may provoke, in accordance with the testing protocol, a plurality of second voice-based interactions between the AI testing model 404 and the AI agent 402. The testing protocol may indicate that respective second voice-based interactions of the plurality of second voice-based interactions are to be performed in accordance with respective second voice-based interaction scenarios and respective second personas of the plurality of personas.

In some examples, at 438, the server 408 may adjust, based on the report, one or more parameters of the AI agent 402.

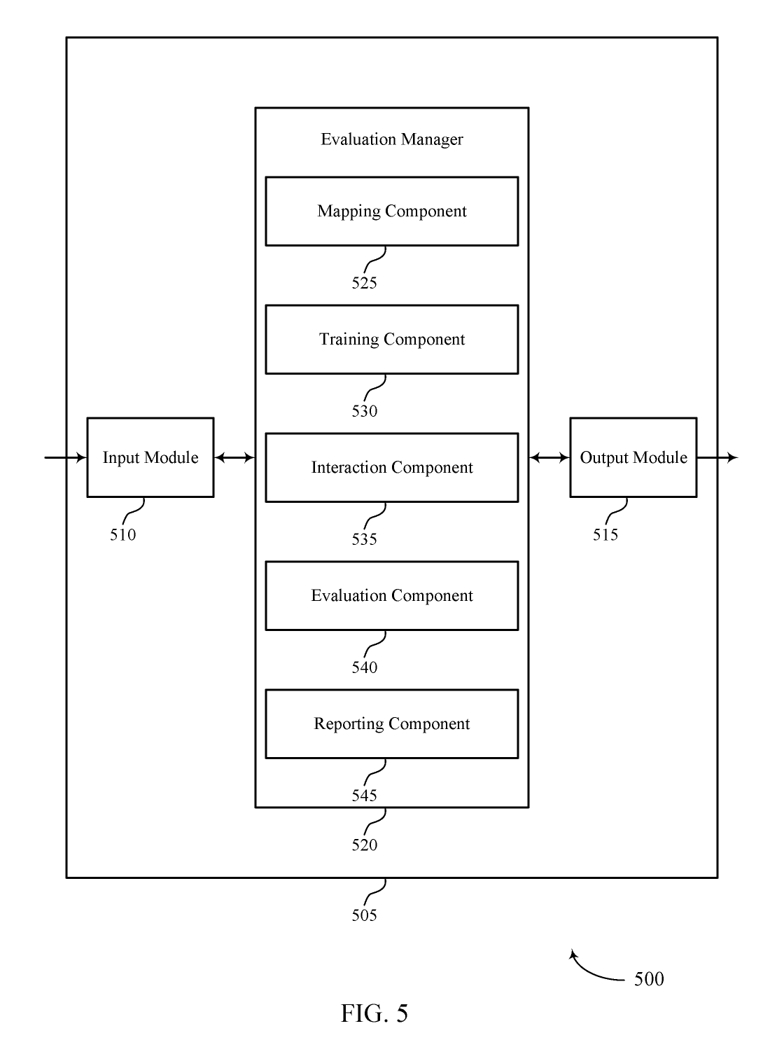

FIG. 5 shows a block diagram 500 of a device 505 that supports evaluation of voice-based AI agents in accordance with examples as disclosed herein. The device 505 may include an input module 510, an output module 515, and an evaluation manager 520. The device 505, or one or more components of the device 505 (e.g., the input module 510, the output module 515, the evaluation manager 520), may include at least one processor, which may be coupled with at least one memory, to support the described techniques. Each of these components may be in communication with one another (e.g., via one or more buses).

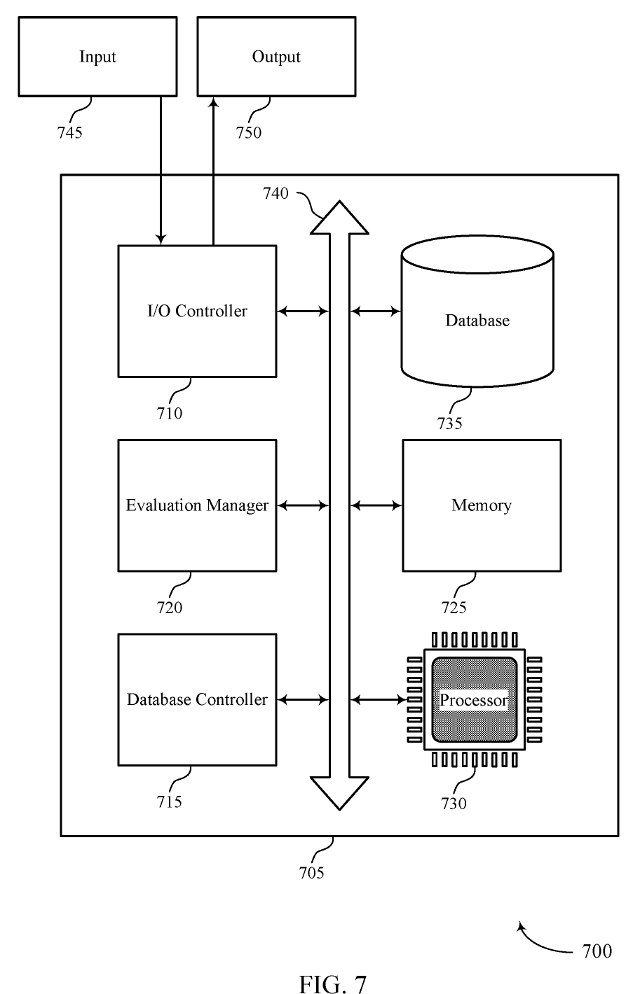

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the evaluation manager 520 to support evaluation of voice-based AI agents. In some cases, the input module 510 may be a component of an input/output (I/O) controller 710 as described with reference to FIG. 7.

The output module 515 may manage output signals for the device 505. For example, the output module 515 may receive signals from other components of the device 505, such as the evaluation manager 520, and may transmit these signals to other components or devices. In some examples, the output module 515 may transmit output signals for display in a user interface, for storage in a database or data store, for further processing at a server or server cluster, or for any other processes at any quantity of devices or systems. In some cases, the output module 515 may be a component of an I/O controller 710 as described with reference to FIG. 7.

For example, the evaluation manager 520 may include a mapping component 525, a training component 530, an interaction component 535, an evaluation component 540, a reporting component 545, or any combination thereof. In some examples, the evaluation manager 520, or various components thereof, may be configured to perform various operations (e.g., receiving, monitoring, transmitting) using or otherwise in cooperation with the input module 510, the output module 515, or both. For example, the evaluation manager 520 may receive information from the input module 510, send information to the output module 515, or be integrated in combination with the input module 510, the output module 515, or both to receive information, transmit information, or perform various other operations as described herein.

The evaluation manager 520 may support evaluation of an AI agent in accordance with examples as disclosed herein. The mapping component 525 may be configured to support mapping, to a set of multiple voice-based interaction scenarios, a set of multiple personas that each indicate a set of multiple respective voice-based interaction characteristics that are based on a subset of stored training data that are representative of the set of multiple respective voice-based interaction characteristics. The training component 530 may be configured to support training an AI testing model capable of performing voice-based interactions that are in accordance with a first voice-based interaction scenario of the set of multiple voice-based interaction scenarios and that are based on the respective voice-based interaction characteristics indicated by a first persona of the set of multiple personas. The interaction component 535 may be configured to support provoking, in accordance with a testing protocol, a first voice-based interaction between the AI testing model and the AI agent. The evaluation component 540 may be configured to support evaluating the first voice-based interaction based on one or more voice interaction metrics. The reporting component 545 may be configured to support generating a report indicating the one or more voice interaction metrics and one or more results of the evaluation.

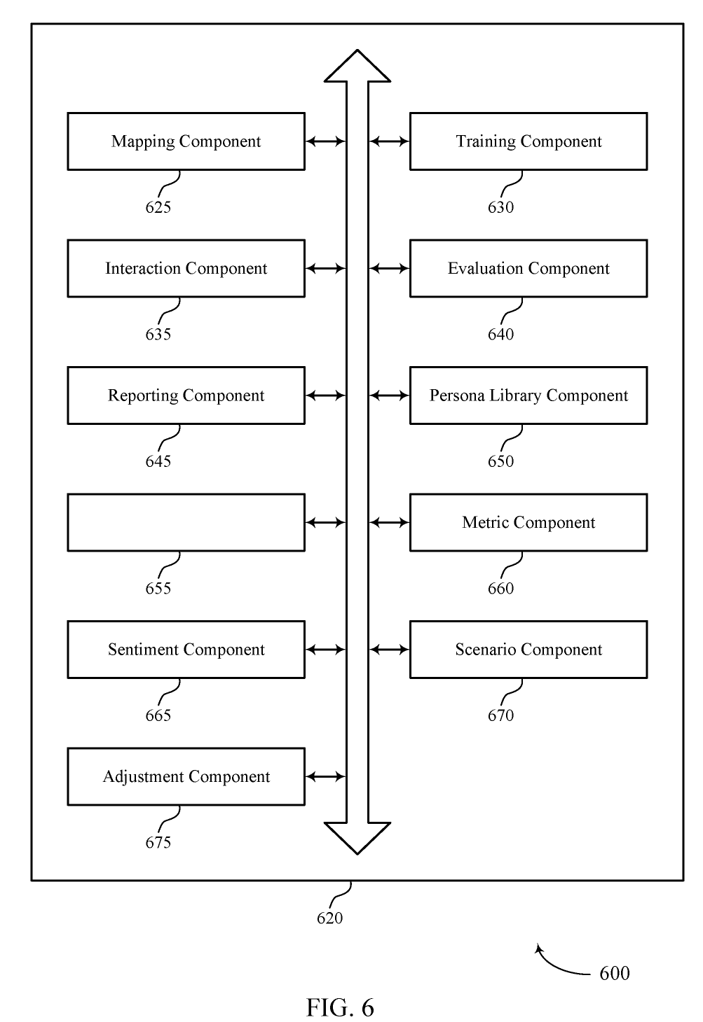

FIG. 6 shows a block diagram 600 of an evaluation manager 620 that supports evaluation of voice-based AI agents in accordance with examples as disclosed herein. The evaluation manager 620 may be an example of aspects of an evaluation manager or an evaluation manager 520, or both, as described herein. The evaluation manager 620, or various components thereof, may be an example of means for performing (e.g., to cause the evaluation manager 620 to perform) various aspects of evaluation of voice-based AI agents as described herein. For example, the evaluation manager 620 may include a mapping component 625, a training component 630, an interaction component 635, an evaluation component 640, a reporting component 645, a persona library component 650, a metric component 660, a sentiment component 665, a scenario component 670, an adjustment component 675, or any combination thereof. Each of these components, or components of subcomponents thereof (e.g., one or more processors, one or more memories), may communicate, directly or indirectly, with one another (e.g., via one or more buses).

The evaluation manager 620 may support evaluation of an AI agent in accordance with examples as disclosed herein. The mapping component 625 may be configured to support mapping, to a set of multiple voice-based interaction scenarios, a set of multiple personas that each indicate a set of multiple respective voice-based interaction characteristics that are based on a subset of stored training data that are representative of the set of multiple respective voice-based interaction characteristics. The training component 630 may be configured to support training an AI testing model capable of performing voice-based interactions that are in accordance with a first voice-based interaction scenario of the set of multiple voice-based interaction scenarios and that are based on the respective voice-based interaction characteristics indicated by a first persona of the set of multiple personas. The interaction component 635 may be configured to support provoking, in accordance with a testing protocol, a first voice-based interaction between the AI testing model and the AI agent. The evaluation component 640 may be configured to support evaluating the first voice-based interaction based on one or more voice interaction metrics. The reporting component 645 may be configured to support generating a report indicating the one or more voice interaction metrics and one or more results of the evaluation.

In some examples, the persona library component 650 may be configured to support receiving input indicating a first selection of the first persona from among the set of multiple personas and a second selection of the first voice-based interaction scenario from among the set of multiple voice-based interaction scenarios.

In some examples, the persona library component 650 may be configured to support provoking, in accordance with the testing protocol, a set of multiple second voice-based interactions between the AI testing model and the AI agent, where the testing protocol indicates that respective second voice-based interactions of the set of multiple second voice-based interactions are to be performed in accordance with respective second voice-based interaction scenarios and respective second personas of the set of multiple personas.

In some examples, the persona generation component 655 may be configured to support generating, based on received input indicating a selection of one or more voice-based interaction characteristics of the set of multiple voice-based interaction characteristics, a user-defined persona. In some examples, the persona generation component 655 may be configured to support associating the user-defined persona with the set of multiple personas.

In some examples, the persona generation component 655 may be configured to support generating, based on received input indicating one or more interaction scenario characteristics, a user-defined voice-based interaction scenario. In some examples, the persona generation component 655 may be configured to support associating the user-defined voice-based interaction scenario with the set of multiple voice-based interaction scenarios.

In some examples, the one or more voice interaction metrics include a conciseness metric, a responsiveness metric, an interruption handling metric, an empathy metric, a sentiment analysis metric, or any combination thereof.

In some examples, the AI agent is configured to perform, in connection with the first voice-based interaction, a sentiment analysis of voice input received at the AI agent. In some examples, the evaluation of the first voice-based interaction is based on an evaluation of the sentiment analysis.

In some examples, each persona of the set of multiple personas indicates one or more conversational elements associated with one or more moods, one or more roles, one or more tones, one or more emotions, one or more interruption events, or any combination thereof, that are indicated by the subset of the stored training data.

In some examples, to support evaluating the first voice-based interaction, the evaluation component 640 may be configured to support evaluating one or more responses generated by the AI agent to the one or more conversational elements that are generated by the AI testing model.

In some examples, the scenario component 670 may be configured to support injecting background noise corresponding with the first voice-based interaction scenario into the first voice-based interaction, where evaluating the first voice-based interaction includes evaluating one or more responses generated by the AI agent in response to the background noise.

In some examples, the adjustment component 675 may be configured to support adjusting, based on the report, one or more parameters of the AI agent.

FIG. 7 shows a diagram of a system 700 including a device 705 that supports evaluation of voice-based AI agents in accordance with examples as disclosed herein. The device 705 may be an example of or include components of a device 505 as described herein. The device 705 may include components for bi-directional data communications including components for transmitting and receiving communications, such as an evaluation manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting evaluation of voice-based AI agents). The processor 730 may be an example of a single processor or multiple processors. For example, the device 705 may include one or more processors 730.

The evaluation manager 720 may support evaluation of an AI agent in accordance with examples as disclosed herein. For example, the evaluation manager 720 may be configured to support mapping, to a set of multiple voice-basing interaction scenarios, a set of multiple personas that each indicate a set of multiple respective voice-based interaction characteristics that are based on a subset of stored training data that are representative of the set of multiple respective voice-based interaction characteristics. The evaluation manager 720 may be configured to support training an AI testing model capable of performing voice-based interactions that are in accordance with a first voice-based interaction scenario of the set of multiple voice-based interaction scenarios and that are based on the respective voice-based interaction characteristics indicated by a first persona of the set of multiple personas. The evaluation manager 720 may be configured to support provoking, in accordance with a testing protocol, a first voice-basing interaction between the AI testing model and the AI agent. The evaluation manager 720 may be configured to support evaluating the first voice-based interaction based on one or more voice interaction metrics. The evaluation manager 720 may be configured to support generating a report indicating the one or more voice interaction metrics and one or more results of the evaluation.

By including or configuring the evaluation manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

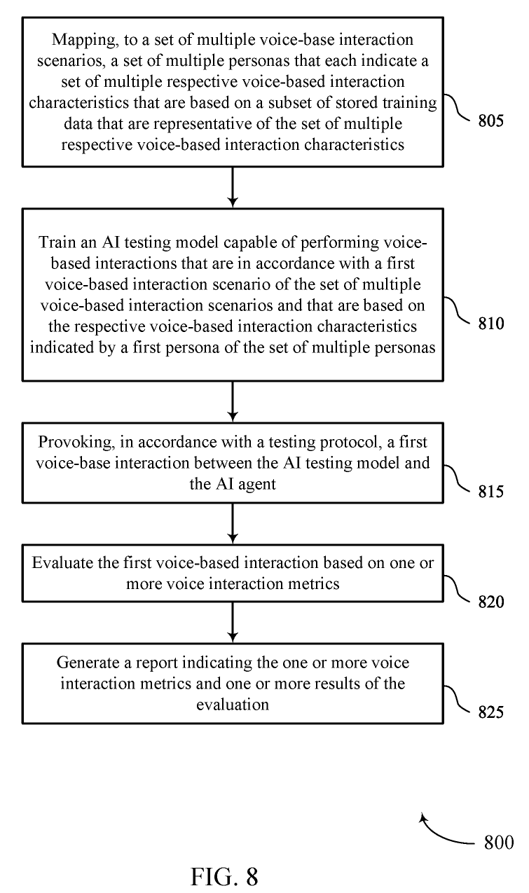

FIG. 8 shows a flowchart illustrating a method 800 that supports evaluation of voice-based AI agents in accordance with examples as disclosed herein. The operations of the method 800 may be implemented by an application server or its components as described herein. For example, the operations of the method 800 may be performed by an application server as described with reference to FIGS. 1-7. In some examples, an application server may execute a set of instructions to control the functional elements of the application server to perform the described functions. Additionally, or alternatively, the application server may perform aspects of the described functions using special-purpose hardware.

At 805, the method may include mapping, to a set of multiple voice-based interaction scenarios, a set of multiple personas that each indicate a set of multiple respective voice-based interaction characteristics that are based on a subset of stored training data that are representative of the set of multiple respective voice-based interaction characteristics. The operations of 805 may be performed in accordance with examples as disclosed herein. In some examples, aspects of the operations of 805 may be performed by a mapping component 625.

At 810, the method may include training an AI testing model capable of performing voice-based interactions that are in accordance with a first voice-based interaction scenario of the set of multiple voice-based interaction scenarios and that are based on the respective voice-based interaction characteristics indicated by a first persona of the set of multiple personas. The operations of 810 may be performed in accordance with examples as disclosed herein. In some examples, aspects of the operations of 810 may be performed by a training component 630.

At 815, the method may include provoking, in accordance with a testing protocol, a first voice-based interaction between the AI testing model and the AI agent. The operations of 815 may be performed in accordance with examples as disclosed herein. In some examples, aspects of the operations of 815 may be performed by an interaction component 635.

At 820, the method may include evaluating the first voice-based interaction based on one or more voice interaction metrics. The operations of 820 may be performed in accordance with examples as disclosed herein. In some examples, aspects of the operations of 820 may be performed by an evaluation component 640.

At 825, the method may include generating a report indicating the one or more voice interaction metrics and one or more results of the evaluation. The operations of 825 may be performed in accordance with examples as disclosed herein. In some examples, aspects of the operations of 825 may be performed by a reporting component 645.

A method for evaluation of an AI agent by an apparatus is described. The method may include mapping, to a set of multiple voice-based interaction scenarios, a set of multiple personas that each indicate a set of multiple respective voice-based interaction characteristics that are based on a subset of stored training data that are representative of the set of multiple respective voice-based interaction characteristics, training an AI testing model capable of performing voice-based interactions that are in accordance with a first voice-based interaction scenario of the set of multiple voice-based interaction scenarios and that are based on the respective voice-based interaction characteristics indicated by a first persona of the set of multiple personas, provoking, in accordance with a testing protocol, a first voice-based interaction between the AI testing model and the AI agent, evaluating the first voice-based interaction based on one or more voice interaction metrics, and generating a report indicating the one or more voice interaction metrics and one or more results of the evaluation.

An apparatus for evaluation of an AI agent is described. The apparatus may include one or more memories storing processor executable code, and one or more processors coupled with the one or more memories. The one or more processors may individually or collectively be operable to execute the code to cause the apparatus to mapping, to a set of multiple voice-based interaction scenarios, a set of multiple personas that each indicate a set of multiple respective voice-based interaction characteristics that are based on a subset of stored training data that are representative of the set of multiple respective voice-based interaction characteristics, train an AI testing model capable of performing voice-based interactions that are in accordance with a first voice-based interaction scenario of the set of multiple voice-based interaction scenarios and that are based on the respective voice-based interaction characteristics indicated by a first persona of the set of multiple personas, provoking, in accordance with a testing protocol, a first voice-based interaction between the AI testing model and the AI agent, evaluate the first voice-based interaction based on one or more voice interaction metrics, and generate a report indicating the one or more voice interaction metrics and one or more results of the evaluation.

Another apparatus for evaluation of an AI agent is described. The apparatus may include means for mapping, to a set of multiple voice-based interaction scenarios, a set of multiple personas that each indicate a set of multiple respective voice-based interaction characteristics that are based on a subset of stored training data that are representative of the set of multiple respective voice-based interaction characteristics, means for training an AI testing model capable of performing voice-based interactions that are in accordance with a first voice-based interaction scenario of the set of multiple voice-based interaction scenarios and that are based on the respective voice-based interaction characteristics indicated by a first persona of the set of multiple personas, means for provoking, in accordance with a testing protocol, a first voice-based interaction between the AI testing model and the AI agent, means for evaluating the first voice-based interaction based on one or more voice interaction metrics, and means for generating a report indicating the one or more voice interaction metrics and one or more results of the evaluation.

A non-transitory computer-readable medium storing code for evaluation of an AI agent is described. The code may include instructions executable by one or more processors to mapping, to a set of multiple voice-based interaction scenarios, a set of multiple personas that each indicate a set of multiple respective voice-based interaction characteristics that are based on a subset of stored training data that are representative of the set of multiple respective voice-based interaction characteristics, train an AI testing model capable of performing voice-based interactions that are in accordance with a first voice-based interaction scenario of the set of multiple voice-based interaction scenarios and that are based on the respective voice-based interaction characteristics indicated by a first persona of the set of multiple personas, provoking, in accordance with a testing protocol, a first voice-based interaction between the AI testing model and the AI agent, evaluate the first voice-based interaction based on one or more voice interaction metrics, and generate a report indicating the one or more voice interaction metrics and one or more results of the evaluation.

Some examples of the method, apparatus, and non-transitory computer-readable medium described herein may further include operations, features, means, or instructions for receiving input indicating a first selection of the first persona from among the set of multiple personas and a second selection of the first voice-based interaction scenario from among the set of multiple voice-based interaction scenarios.

In some examples of the method, apparatus, and non-transitory computer-readable medium described herein, provoking, in accordance with the testing protocol, a set of multiple second voice-based interactions between the AI testing model and the AI agent, where the testing protocol indicates that respective second voice-based interactions of the set of multiple second voice-based interactions are to be performed in accordance with respective second voice-based interaction scenarios and respective second personas of the set of multiple personas.

Some examples of the method, apparatus, and non-transitory computer-readable medium described herein may further include operations, features, means, or instructions for generating, based on received input indicating a selection of one or more voice-based interaction characteristics of the set of multiple voice-based interaction characteristics, a user-defined persona and associating the user-defined persona with the set of multiple personas.

Some examples of the method, apparatus, and non-transitory computer-readable medium described herein may further include operations, features, means, or instructions for generating, based on received input indicating one or more interaction scenario characteristics, a user-defined voice-based interaction scenario and associating the user-defined voice-based interaction scenario with the set of multiple voice-based interaction scenarios.

In some examples of the method, apparatus, and non-transitory computer-readable medium described herein, the one or more voice interaction metrics include a conciseness metric, a responsiveness metric, an interruption handling metric, an empathy metric, a sentiment analysis metric, or any combination thereof.

In some examples of the method, apparatus, and non-transitory computer-readable medium described herein, the AI agent may be configured to perform, in connection with the first voice-based interaction, a sentiment analysis of voice input received at the AI agent and the evaluation of the first voice-based interaction may be based on an evaluation of the sentiment analysis.

In some examples of the method, apparatus, and non-transitory computer-readable medium described herein, each persona of the set of multiple personas indicates one or more conversational elements associated with one or more moods, one or more roles, one or more tones, one or more emotions, one or more interruption events, or any combination thereof, that may be indicated by the subset of the stored training data.

In some examples of the method, apparatus, and non-transitory computer-readable medium described herein, evaluating the first voice-based interaction may include operations, features, means, or instructions for evaluating one or more responses generated by the AI agent to the one or more conversational elements that may be generated by the AI testing model.

Some examples of the method, apparatus, and non-transitory computer-readable medium described herein may further include operations, features, means, or instructions for injecting background noise corresponding with the first voice-based interaction scenario into the first voice-based interaction, where evaluating the first voice-based interaction includes evaluating one or more responses generated by the AI agent in response to the background noise.

Some examples of the method, apparatus, and non-transitory computer-readable medium described herein may further include operations, features, means, or instructions for adjusting, based on the report, one or more parameters of the AI agent.

The following provides an overview of aspects of the present disclosure:

Aspect 1: A method for evaluation of an artificial intelligence (AI) agent, the method comprising: mapping, to a plurality of voice-based interaction scenarios, a plurality of personas that each indicate a plurality of respective voice-based interaction characteristics that are based at least in part on a subset of stored training data that are representative of the plurality of respective voice-based interaction characteristics; training an AI testing model capable of performing voice-based interactions that are in accordance with a first voice-based interaction scenario of the plurality of voice-based interaction scenarios and that are based at least in part on the respective voice-based interaction characteristics indicated by a first persona of the plurality of personas; provoking, in accordance with a testing protocol, a first voice-based interaction between the AI testing model and the AI agent; evaluating the first voice-based interaction based at least in part on one or more voice interaction metrics; and generating a report indicating the one or more voice interaction metrics and one or more results of the evaluation.

Aspect 2: The method of aspect 1, further comprising: receiving input indicating a first selection of the first persona from among the plurality of personas and a second selection of the first voice-based interaction scenario from among the plurality of voice-based interaction scenarios.

Aspect 3: The method of any of aspects 1 through 2, further comprising: provoking, in accordance with the testing protocol, a plurality of second voice-based interactions between the AI testing model and the AI agent, wherein the testing protocol indicates that respective second voice-based interactions of the plurality of second voice-based interactions are to be performed in accordance with respective second voice-based interaction scenarios and respective second personas of the plurality of personas.

Aspect 4: The method of any of aspects 1 through 3, further comprising: generating, based at least in part on received input indicating a selection of one or more voice-based interaction characteristics of the plurality of voice-based interaction characteristics, a user-defined persona; and associating the user-defined persona with the plurality of personas.

Aspect 5: The method of any of aspects 1 through 4, further comprising: generating, based at least in part on received input indicating one or more interaction scenario characteristics, a user-defined voice-based interaction scenario; and associating the user-defined voice-based interaction scenario with the plurality of voice-based interaction scenarios.

Aspect 6: The method of any of aspects 1 through 5, wherein the one or more voice interaction metrics comprise a conciseness metric, a responsiveness metric, an interruption handling metric, an empathy metric, a sentiment analysis metric, or any combination thereof.

Aspect 7: The method of any of aspects 1 through 6, wherein the AI agent is configured to perform, in connection with the first voice-based interaction, a sentiment analysis of voice input received at the AI agent; and the evaluation of the first voice-based interaction is based at least in part on an evaluation of the sentiment analysis.

Aspect 8: The method of any of aspects 1 through 7, wherein each persona of the plurality of personas indicates one or more conversational elements associated with one or more moods, one or more roles, one or more tones, one or more emotions, one or more interruption events, or any combination thereof, that are indicated by the subset of the stored training data.

Aspect 9: The method of aspect 8, wherein evaluating the first voice-based interaction comprises: evaluating one or more responses generated by the AI agent to the one or more conversational elements that are generated by the AI testing model.

Aspect 10: The method of any of aspects 1 through 9, further comprising: injecting background noise corresponding with the first voice-based interaction scenario into the first voice-based interaction, wherein evaluating the first voice-based interaction comprises evaluating one or more responses generated by the AI agent in response to the background noise.

Aspect 11: The method of any of aspects 1 through 10, further comprising: adjusting, based at least in part on the report, one or more parameters of the AI agent.

Aspect 12: An apparatus for evaluation of an artificial intelligence (AI) agent, comprising one or more memories storing processor-executable code, and one or more processors coupled with the one or more memories and individually or collectively operable to execute the code to cause the apparatus to perform a method of any of aspects 1 through 11.

Aspect 13: An apparatus for evaluation of an artificial intelligence (AI) agent, comprising at least one means for performing a method of any of aspects 1 through 11.

Aspect 14: A non-transitory computer-readable medium storing code for evaluation of an artificial intelligence (AI) agent, the code comprising instructions executable by one or more processors to perform a method of any of aspects 1 through 11.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for evaluation of an artificial intelligence (AI) agent, the method comprising:
mapping, to a plurality of voice-based interaction scenarios, a plurality of personas that each indicate a plurality of respective voice-based interaction characteristics that are based at least in part on a subset of stored training data that are representative of the plurality of respective voice-based interaction characteristics;
training an AI testing model capable of performing voice-based interactions that are in accordance with a first voice-based interaction scenario of the plurality of voice-based interaction scenarios and that are based at least in part on the respective voice-based interaction characteristics indicated by a first persona of the plurality of personas;
provoking, in accordance with a testing protocol, a first voice-based interaction between the AI testing model and the AI agent;
evaluating the first voice-based interaction based at least in part on one or more voice interaction metrics; and
generating a report indicating the one or more voice interaction metrics and one or more results of the evaluation.

2. The method of claim 1, further comprising:
receiving input indicating a first selection of the first persona from among the plurality of personas and a second selection of the first voice-based interaction scenario from among the plurality of voice-based interaction scenarios.

3. The method of claim 1, further comprising:
provoking, in accordance with the testing protocol, a plurality of second voice-based interactions between the AI testing model and the AI agent, wherein the testing protocol indicates that respective second voice-based interactions of the plurality of second voice-based interactions are to be performed in accordance with respective second voice-based interaction scenarios and respective second personas of the plurality of personas.

4. The method of claim 1, further comprising:
generating, based at least in part on received input indicating a selection of one or more voice-based interaction characteristics of the plurality of respective voice-based interaction characteristics, a user-defined persona; and
associating the user-defined persona with the plurality of personas.

5. The method of claim 1, further comprising:
generating, based at least in part on received input indicating one or more interaction scenario characteristics, a user-defined voice-based interaction scenario; and
associating the user-defined voice-based interaction scenario with the plurality of voice-based interaction scenarios.

6. The method of claim 1, wherein the one or more voice interaction metrics comprise a conciseness metric, a responsiveness metric, an interruption handling metric, an empathy metric, a sentiment analysis metric, or any combination thereof.

7. The method of claim 1, wherein:
the AI agent is configured to perform, in connection with the first voice-based interaction, a sentiment analysis of voice input received at the AI agent; and
the evaluation of the first voice-based interaction is based at least in part on an evaluation of the sentiment analysis.

8. The method of claim 1, wherein each persona of the plurality of personas indicates one or more conversational elements associated with one or more moods, one or more roles, one or more tones, one or more emotions, one or more interruption events, or any combination thereof, that are indicated by the subset of the stored training data.

9. The method of claim 8, wherein evaluating the first voice-based interaction comprises:
evaluating one or more responses generated by the AI agent to the one or more conversational elements that are generated by the AI testing model.

10. The method of claim 1, further comprising:
injecting background noise corresponding with the first voice-based interaction scenario into the first voice-based interaction, wherein evaluating the first voice-based interaction comprises evaluating one or more responses generated by the AI agent in response to the background noise.

11. The method of claim 1, further comprising:
adjusting, based at least in part on the report, one or more parameters of the AI agent.

12. An apparatus for evaluation of an artificial intelligence (AI) agent, comprising:
one or more memories storing processor-executable code; and
one or more processors coupled with the one or more memories and individually or collectively operable to execute the code to cause the apparatus to:
map, to a plurality of voice-based interaction scenarios, a plurality of personas that each indicate a plurality of respective voice-based interaction characteristics that are based at least in part on a subset of stored training data that are representative of the plurality of respective voice-based interaction characteristics;
train an AI testing model capable of performing voice-based interactions that are in accordance with a first voice-based interaction scenario of the plurality of voice-based interaction scenarios and that are based at least in part on the respective voice-based interaction characteristics indicated by a first persona of the plurality of personas;
provoke, in accordance with a testing protocol, a first voice-based interaction between the AI testing model and the AI agent;
evaluate the first voice-based interaction based at least in part on one or more voice interaction metrics; and
generate a report indicating the one or more voice interaction metrics and one or more results of the evaluation.

13. The apparatus of claim 12, wherein the one or more processors are individually or collectively further operable to execute the code to cause the apparatus to:
receive input indicating a first selection of the first persona from among the plurality of personas and a second selection of the first voice-based interaction scenario from among the plurality of voice-based interaction scenarios.

14. The apparatus of claim 12, wherein the one or more processors are individually or collectively further operable to execute the code to cause the apparatus to:
provoke, in accordance with the testing protocol, a plurality of second voice-based interactions between the AI testing model and the AI agent, wherein the testing protocol indicates that respective second voice-based interactions of the plurality of second voice-based interactions are to be performed in accordance with respective second voice-based interaction scenarios and respective second personas of the plurality of personas.

15. The apparatus of claim 12, wherein the one or more processors are individually or collectively further operable to execute the code to cause the apparatus to:
generate, based at least in part on received input indicating a selection of one or more voice-based interaction characteristics of the plurality of respective voice-based interaction characteristics, a user-defined persona; and
associate the user-defined persona with the plurality of personas.

16. The apparatus of claim 12, wherein the one or more processors are individually or collectively further operable to execute the code to cause the apparatus to:
generate, based at least in part on received input indicating one or more interaction scenario characteristics, a user-defined voice-based interaction scenario; and
associate the user-defined voice-based interaction scenario with the plurality of voice-based interaction scenarios.

17. The apparatus of claim 12, wherein the one or more voice interaction metrics comprise a conciseness metric, a responsiveness metric, an interruption handling metric, an empathy metric, a sentiment analysis metric, or any combination thereof.

18. The apparatus of claim 12, wherein:
the AI agent is configured to perform, in connection with the first voice-based interaction, a sentiment analysis of voice input received at the AI agent; and
the evaluation of the first voice-based interaction is based at least in part on an evaluation of the sentiment analysis.

19. The apparatus of claim 12, wherein each persona of the plurality of personas indicates one or more conversational elements associated with one or more moods, one or more roles, one or more tones, one or more emotions, one or more interruption events, or any combination thereof, that are indicated by the subset of the stored training data.

20. A non-transitory computer-readable medium storing code for evaluation of an artificial intelligence (AI) agent, the code comprising instructions executable by one or more processors to:
map, to a plurality of voice-based interaction scenarios, a plurality of personas that each indicate a plurality of respective voice-based interaction characteristics that are based at least in part on a subset of stored training data that are representative of the plurality of respective voice-based interaction characteristics;
train an AI testing model capable of performing voice-based interactions that are in accordance with a first voice-based interaction scenario of the plurality of voice-based interaction scenarios and that are based at least in part on the respective voice-based interaction characteristics indicated by a first persona of the plurality of personas;
provoke, in accordance with a testing protocol, a first voice-based interaction between the AI testing model and the AI agent;
evaluate the first voice-based interaction based at least in part on one or more voice interaction metrics; and
generate a report indicating the one or more voice interaction metrics and one or more results of the evaluation.
